(19) United States
(12) Patent Application Publication
(10) Pub. No.: US 2014/0360651 A1
(43) Pub. Date: Dec. 11, 2014

(54) FLAT DISPLAY PANEL CUTTING METHOD

(71) Applicant: EverDisplay Optronics (Shanghai) Limited, Shanghai (CN)

(72) Inventors: Chengpei HUANG, Shanghai (CN); Qiguo ZHANG, Shanghai (CN); Chuwan HUANG, Shanghai (CN)

(73) Assignee: EverDisplay Optronics (Shanghai) Limited, Shanghai (CN)

(21) Appl. No.: 14/293,746

(22) Filed: Jun. 2, 2014

(30) Foreign Application Priority Data
Jun. 5, 2013 (CN) 201310222221.9

(51) Int. Cl. B32B 38/00; B32B 37/12

(52) U.S. Cl. CPC B32B 38/0004; B32B 38/0012; B32B 37/1207; B32B 2037/1253; B32B 2038/0016; B32B 2307/412; B32B 2398/10; B32B 2551/00; B32B 2457/206
USPC 156/101; 156/268; 156/154

(57) ABSTRACT

A flat display panel cutting method includes the following steps: coating a first packaging adhesive on a surface of a first substrate at which display units are formed, wherein the first substrate is formed of a first-substrate-material and the first packaging adhesive is made of a first-substrate-material-based material; bonding a second substrate to the surface of the first substrate to form the panel, having a first surface and a second surface opposite to the first surface; forming at least one crack on the first surface of the panel corresponding to the first packaging adhesive with a cutting tool to form at least one crack; applying a force on the second surface at a position corresponding to the at least one crack so as to break the panel.

### CROSS-REFERENCE TO RELATED APPLICATIONS

This application claims benefits of Chinese Patent Application No. 201310222221.9, filed on Jun. 5, 2013 in the State Intellectual Property Office of China, the disclosure of which is incorporated herein by reference in its entirety.

### TECHNICAL FIELD

The present disclosure relates in general to a flat display panel, in particular, to a flat display panel and cutting method thereof.

### BACKGROUND

Presently, substrates or substrate materials can be used for manufacturing various electronic products. For example, a transparent substrate, such as a glass substrate, can be used for manufacturing a display panel. Taking a large size organic light-emitting display (OLED) for example, it can be cut into many organic light-emitting display units. Each OLED unit at least comprises an anode plate, a cathode plate and a light-emitting layer interlaid between the anode plate and the cathode plate to form a “sandwich” structure. Under a positive voltage, the anode plate may inject holes to the light-emitting layer, and the cathode plate may inject electrons to the light-emitting layer. The injected holes and electrons may meet and recombine in the light-emitting layer, which results in the electrons degrading from excited state to ground state and releasing extra energy in the form of light wave.

In particular, FIGS. 1A-1D are schematic views illustrating cutting and splitting process for the panel in the related art.

FIG. 1A illustrates a schematic view of the structure of a flat display panel. The panel 1 comprises a first substrate 11, a second substrate 12, a display unit (not shown) and a packaging adhesive 13. The panel 1 has a first surface 14 and a second surface (referring to the reference number 15 in FIG. 1C). The packaging adhesive 13 can be used for packaging the display unit. The first substrate 11 is bonded to the second substrate 12 by the packaging adhesive 13. While cutting, the first surface 14 acts as an upper surface of the panel 1. FIG. 1A also shows a cutting tool 2, such as a scribe-wheel, for cutting the panel 1. The first surface 14 of the panel 1 is cut by the cutting tool 2.

FIG. 1B illustrates a cross sectional view of the panel. The panel 1 comprises a first substrate 11, a second substrate 12, a display unit (not shown) and packaging adhesive 13. The panel 1 has a first surface 14 and a second surface (referring to the reference number 15 in FIG. 1C). During cutting, the first surface 14 acts as the upper surface of the panel 1. A first crack 141 developed by the cutting tool 2 on the first surface 14 of the panel 1 is corresponding to a space between two adjacent packaging adhesives 13.

FIG. 1C illustrates a schematic view of the structure of the flat display panel. The panel 1 comprises a first substrate 11, a second substrate 12, a display unit (not shown) and packaging adhesive 13. The panel 1 has a first surface 14 and a second surface (referring to the reference number 15 in FIG. 1C). The first substrate 11 is bonded to the second substrate 12 via the packaging adhesive 13. While splitting, the second surface 15 acts as the upper surface of the panel 1. FIG. 1C also shows a splitting tool 3 for cutting the panel 1, such as a splitting rod. The splitting tool 3 applies a force to the position corresponding to the first crack 141 on the second surface 15 of the panel 1.

FIG. 1D illustrates still a cross sectional view of a panel. The panel 1 comprises a first substrate 11, a second substrate 12, a display unit (not shown) and packaging adhesive 13. The panel 1 has a first surface 14 and a second surface 15. The packaging adhesive 13 is used to securely combine the first substrate 11 and the second substrate 12. While splitting, the second surface 15 acts as the upper surface of the panel 1. The splitting tool 3 is positioned on the second surface 15 of the panel 1, which corresponds to the first crack 141, so as to deepen the first crack 141.

FIG. 2 shows a panel cutting flowchart in the related art. The panel, such as a display panel, comprises a first substrate and a second substrate securely combined with the first substrate. The panel has a first surface and a second surface opposite to the first surface. It is to be noted that when performing the method, a coating packaging adhesive is applied to a lower side face of the first substrate to surround each of the display units. To be more specific, the coating packaging adhesive made of a material different from those of the first substrate and the second substrate is precisely controlled to be within the range of 8 mm of width and a 4 mm gap is defined between two adjacent coating packaging adhesive. Then, the first substrate is bonded with the second substrate with the coating packaging adhesive sandwiched there between to form display units. A slit or a crack is formed on the first face of the panel via a cutting roller. Thereafter, the panel is turned around to face up the second substrate to allow a splitting rod to apply a force to the position corresponding to that of the crack in the first substrate to lengthen the crack in the first face. Then, the same process is repeated on the second substrate to eventually separate the panel.

From the description above, it is noted that the entire process involves two times of cutting and splitting to the first substrate and the second substrate. Also, the turning process negatively impacts yield. Additionally, the width and the coating packaging adhesive application location are not easily well controlled. The above information disclosed in this Background section is only for enhancement of understanding of the background of the disclosure and therefore it may contain information that does not form the related art that is already known to a person of ordinary skill in the art.

### SUMMARY

Additional aspects and advantages will be set forth in part in the detailed description which follows and, in part, will be apparent from the description, or may be learned by practice of the disclosure.

According to one aspect of the disclosure, there is provided a cutting method for a flat display panel, and the method comprises the steps of:

coating a first packaging adhesive on a surface of a first substrate at which display units are formed, wherein the first substrate is formed of a first-substrate-material and the first packaging adhesive is made of a first-substrate-material-based material;

bonding a second substrate to the surface of the first substrate to form the panel having a first surface and a second surface opposite to the first surface;

forming at least one crack on the first surface of the panel corresponding to the first packaging adhesive; and

applying a force on the second surface at a position corresponding to the at least one crack so as to break the panel.

According to some embodiments, the first and second substrates are made of transparent material.

According to some embodiments, the first and second substrates are made of acrylic glass.

According to some embodiments, the first packaging adhesive is made of acrylic-based material.

According to some embodiments, the first packaging adhesive fills up spaces between the display units.

According to some embodiments, the first surface is provided with cutting marks, and the second surface is provided with splitting marks corresponding to the cutting marks.

According to some embodiments, the first packaging adhesive is at least coated between the display units and corresponding to the cutting marks.

According to some embodiments, the first packaging adhesive is further coated closely around each of the display units so as to form a closed ring.

According to some embodiments, wherein the step of coating the first packaging adhesive further comprises:

coating a second packaging adhesive at the surface of the first substrate, wherein the second packaging adhesive is coated closely around each of the display units so as to form closed rings and is made of a thermosetting material or a photocurable material.

According to some embodiments, further comprises performing an edge grinding process to the panel after breaking the panel.

According to some embodiments, the cutting tool to make the mark is a scribe-wheel or cutter with teeth.

According to some embodiments, the cutting tool is a scribe-wheel or cutter without teeth.

According to some embodiments, a splitting tool used to break the panel is a splitting rod.

According to some embodiments, the splitting rod is a rubber or plastic splitting rod.

According to some embodiments, the flat display panel is an organic light-emitting display panel, and the display units are organic light-emitting display units.

The present disclosure adopts adhesive with the same material as the substrate instead of sealant in the flat panel display, such that the portion to be separated is formed into an integral structure. Therefore the panel can be separated with just one cutting and breaking process including two steps, i.e., cutting-splitting. The present disclosure can fulfill at least one of the following effects.

First, the panel can be separated with just two steps including cutting process and splitting process which can increase the yield of products.

Second, it is not necessary to precisely control the position to be coated with the packaging adhesive and the coated width.

### BRIEF DESCRIPTION OF THE DRAWINGS

The foregoing and other features and advantages of the disclosure will be apparent to those skilled in the art in view of the following detailed description, taken in conjunction with the accompanying drawings.

FIG. 1A illustrates a schematic view of the structure of a flat display panel in the related art;

FIG. 1B illustrates a cross sectional view of a cut flat display panel in the related art;

FIG. 1C illustrates a schematic view of the structure of a flat display panel in the related art;

FIG. 1D illustrates a cross sectional view of a flat display panel in the related art during splitting process;

FIG. 2 illustrates a flowchart of a method for cutting the flat display panel in the prior art;

FIG. 3 illustrates a flowchart of a flat display panel cutting method according to the first embodiment of the disclosure;

FIG. 4A illustrates a schematic view of the structure of a flat display panel according to the second embodiment of the disclosure;

FIG. 4B illustrates a cross sectional view of a cut flat display panel according to the second embodiment of the disclosure;

FIG. 4C illustrates a schematic view of the structure of a flat display panel according to the second embodiment of the disclosure;

FIG. 4D illustrates a cross sectional view of a flat display panel according to the second embodiment of the disclosure during splitting process;

FIG. 5 illustrates a flowchart of a flat display panel cutting method according to the second embodiment of the disclosure;

FIG. 6A illustrates a schematic view of a flat display panel according to the third embodiment of the disclosure;

FIG. 6B illustrates a cross sectional view of a cut flat display panel according to the third embodiment of the disclosure;

FIG. 6C illustrates a schematic view of the structure of a flat display panel according to the third embodiment of the disclosure;

FIG. 6D illustrates a cross sectional view of a flat display panel according to the third embodiment of the disclosure during splitting process;

FIG. 7 illustrates a flowchart of a cutting method for a flat display panel according to the third embodiment of the disclosure;

FIG. 8A illustrates a schematic view of the structure of a flat display panel according to the fourth embodiment of the disclosure;

FIG. 8B illustrates a cross sectional view of a cut flat display panel according to the fourth embodiment of the disclosure;

FIG. 8C illustrates a schematic view of the structure of a flat display panel according to the fourth embodiment of the disclosure;

FIG. 8D illustrates a cross sectional view of a flat display panel according to the fourth embodiment of the disclosure during splitting process; and

FIG. 9 illustrates a flow chart of a cutting method for a flat display panel according to the fourth embodiment of the disclosure.

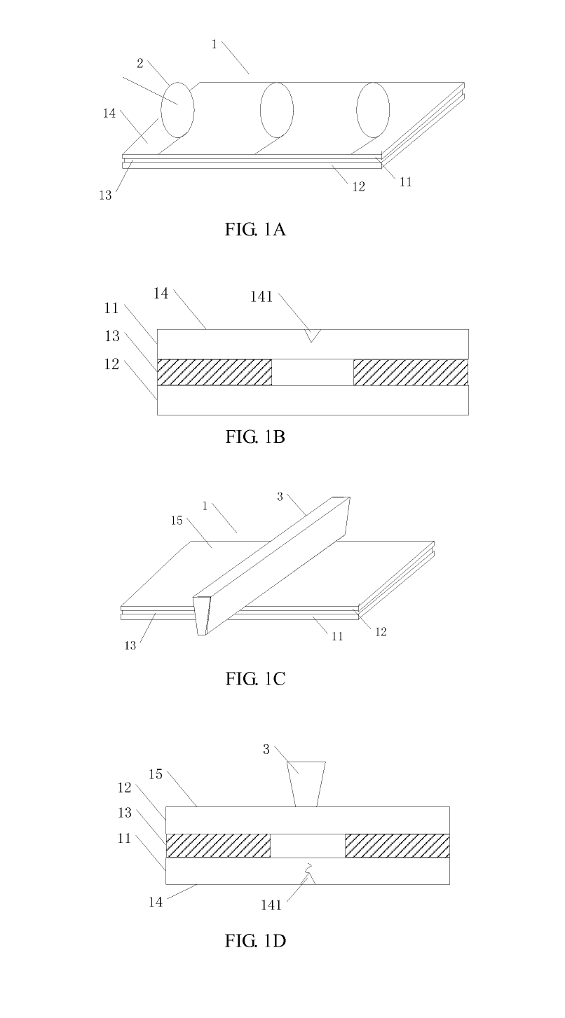

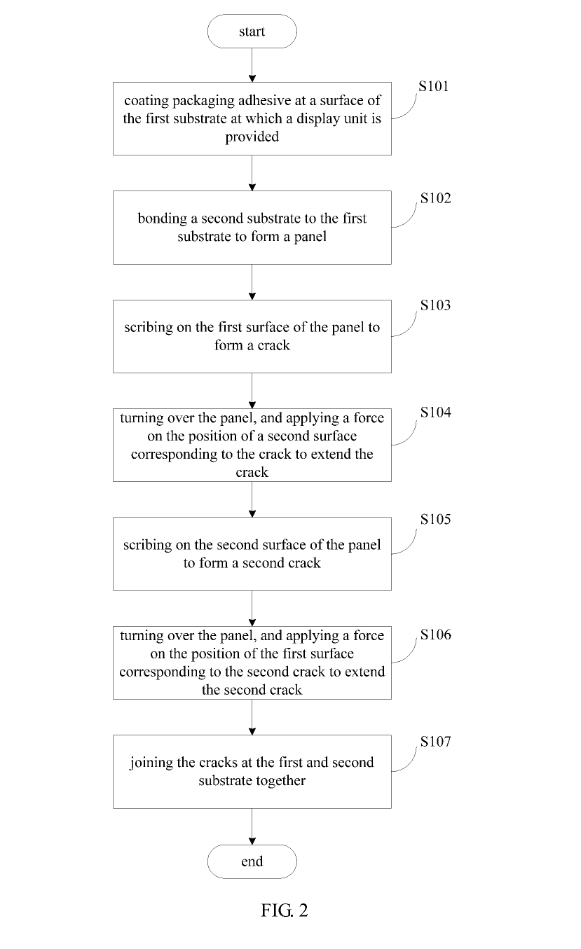

### DETAILED DESCRIPTION

Exemplary embodiments of the disclosure will now be described more fully with reference to the accompanying drawings, in which exemplary embodiments are shown. Exemplary embodiments of the disclosure may, however, be embodied in many different forms and should not be construed as being limited to the embodiments set forth herein; rather, these embodiments are provided so that this disclosure will be thorough and complete, and will fully convey the concept of exemplary embodiments to those skilled in the art. In the drawings, the thicknesses of layers and regions are exaggerated for clarity. Like reference numerals in the drawings denote like elements, and thus their description will be omitted.

The described features, structures, or/and characteristics of the disclosure may be combined in any suitable manner in one or more embodiments. In the following description, numerous specific details are disclosed to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

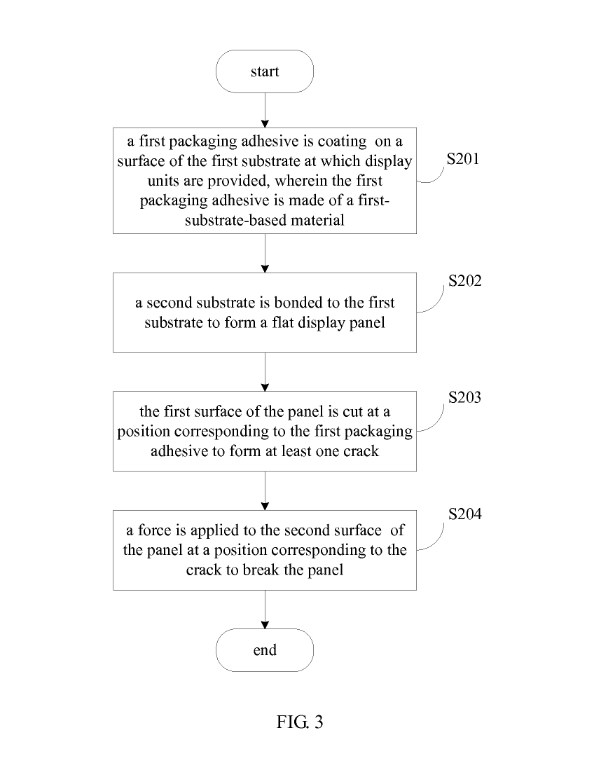

FIG. 3 illustrates a flowchart of a flat panel display cutting method according to the first embodiment of the disclosure.

Step S201:

A first packaging adhesive is coated on a surface of the first substrate at which multiple display units are formed. The first packaging adhesive is made of a first-substrate-material-based material. In particular, the first substrate is made of transparent material, such as glass. Correspondingly, the first packaging adhesive is made of glass-based material. For example, the first substrate is made of acrylic glass, thus the first packaging adhesive is made of acrylic-based material.

Step S202:

A second substrate is bonded to the surface of the first substrate to form the flat display panel. In particular, the material of the second substrate is the same as that of the first substrate, which is a transparent material, such as glass etc.

Step S203:

The first surface of the panel is cut at a position corresponding to the first packaging adhesive by a cutting tool to form at least one crack. In particular, the cutting tool is a cutter or scribe-wheel with or without teeth, such as a cutting roller, Tungsten steel cutting roller, glasscutter, laser or high-pressure water cutter etc.

Step S204:

A force is applied to the second surface of the panel at a position corresponding to the crack by a splitting tool, so as to break the panel. The second surface is opposite to the first surface. In particular, since the first packaging adhesive is made of the first-substrate-material-based material, and the material of the second substrate is the same as that of the first substrate, e.g. the first substrate is made of Acrylic glass, and the first packaging adhesive is made of acrylic-based material, the portion to be cut is formed into an integral structure with same material. When a force is applied to the second surface, the crack on the first surface extends to the second surface through the first packaging adhesive so as to break the panel. In particular, the splitting tool may be a splitting rod, such as a rubber or plastic splitting rod etc.

In a modified embodiment, an edge grinding process is further performed on the separated panel after Step S204. Cutting scratches are formed on the panel after the panel is separated, thus, the cut panel is smoothed on the edge to flatten the edge so that the strength of the panel can be enhanced.

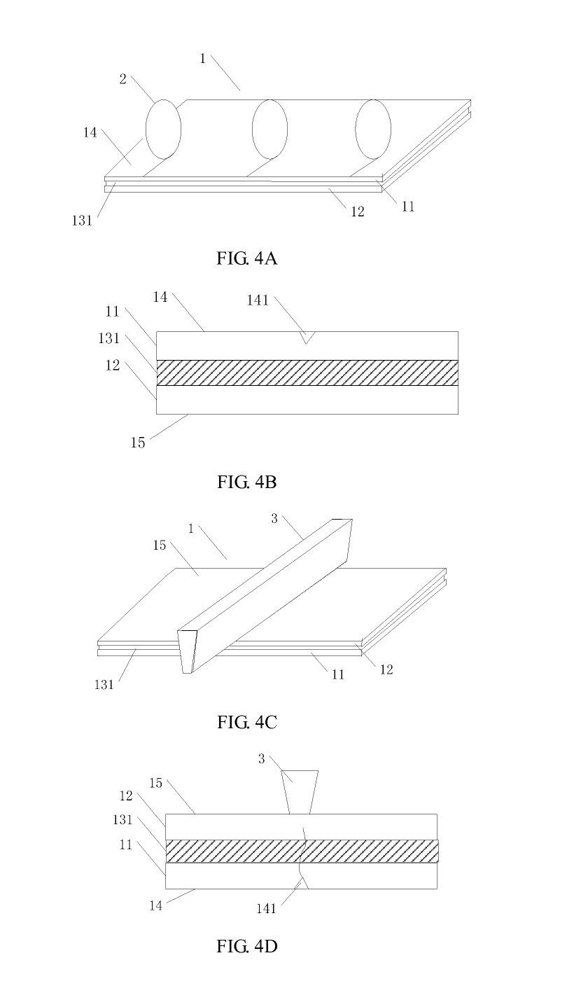

FIGS. 4A, 4B, 4C and 4D illustrate a schematic view of cutting and breaking process for the flat display panel according to the second embodiment of the disclosure.

FIG. 4A illustrates a schematic view of a flat display panel according to the second embodiment of the disclosure. As shown in FIG. 4A, the panel 1 comprises a first substrate 11, OLED units (not shown) provided at the lower surface of the first substrate 11, a second substrate 12 corresponding to the first substrate 11, and a first packaging adhesive 131 made of the first-substrate-material-based material. The panel 1 has a first surface 14 and a second surface opposite to the first surface 14 (referring to the reference number 15 in FIG. 4B). The first substrate 11 is bonded to the second substrate 12 via the first packaging adhesive 131. During the cutting process, the first surface 14 acts as an upper surface of the panel 1. Additionally, FIG. 4A shows a cutting tool 2. The cutting tool 2 is used to cut the first surface 14 of the panel 1 so as to form cracks (referring to the reference number 141 in FIG. 4B).

FIG. 4B illustrates a cross sectional view of the flat display panel according to the second embodiment of the disclosure, in which the panel has been cut. As shown in FIG. 4B, the panel 1 comprises a first substrate 11, OLED units (not shown) provided at the lower surface of the first substrate 11, a second substrate 12, and a first packaging adhesive 131 made of the first-substrate-material-based material. The panel 1 has a first surface 14 and a second surface 15 opposite to the first surface. During the cutting process, the first surface 14 acts as an upper surface of the panel 1. The first substrate 11 is bonded to the second substrate 12 via the first packaging adhesive 131. The first packaging adhesive 131 is coated between the first substrate 11 and the second substrate 12, and is used for filling spaces between OLED units. The portions of the panel 1 corresponding to the cracks 141 are formed into an integral structure with same material.

FIG. 4C illustrates a schematic view of the structure of a flat display panel according to the second embodiment of the disclosure. As shown in FIG. 4C, the panel 1 comprises a first substrate 11, OLED units (not shown) provided at the lower surface of the first substrate 11, a second substrate 12 corresponding to the first substrate 11, and a first packaging adhesive 131 made of the first-substrate-material-based material. The panel 1 has a first surface 14 and a second surface opposite to the first surface 14. During cutting, the first surface 14 acts as an upper surface of the panel 1. The first substrate 11 is bonded to the second substrate 12 via the first packaging adhesive 131. During splitting, the second surface 15 acts as an upper surface of the panel 1. Additionally, FIG. 4C shows a splitting tool 3, such as a splitting rod. The splitting tool 3 applies force to the second surface 15 of the panel 1 at a position corresponding to the crack 141 on the first surface 14.

FIG. 4D illustrates a cross sectional view of the panel of the flat panel according to the second embodiment of the disclosure during splitting process. As shown in FIG. 4D, the panel 1 comprises a first substrate 11, OLED units (not shown) provided at the lower surface of the first substrate 11, a second substrate 12, and a first packaging adhesive 131 made of the first-substrate-material-based material. The panel 1 has a first surface 14 and a second surface 15 opposite to the first surface 14. The first substrate 11 is bonded to the second substrate 12 via the first packaging adhesive 131. During splitting, the second surface 15 acts as an upper surface of the panel 1. FIG. 4D also shows a splitting tool 3. The splitting tool 3 applies a force to the second surface 15 of the panel 1 at a position corresponding to the crack 141 on the first surface. The first packaging adhesive 131 is made of the first-substrate-material-based material, and the material of the second substrate 12 is the same as that of the first substrate 11. Therefore, the portion to be cut is formed into an integral structure with same material. When a force is applied to the second surface 15, the crack 141 on the first surface 14 extends to the second surface 15 through the first packaging adhesive 1 so as to break the panel 1.

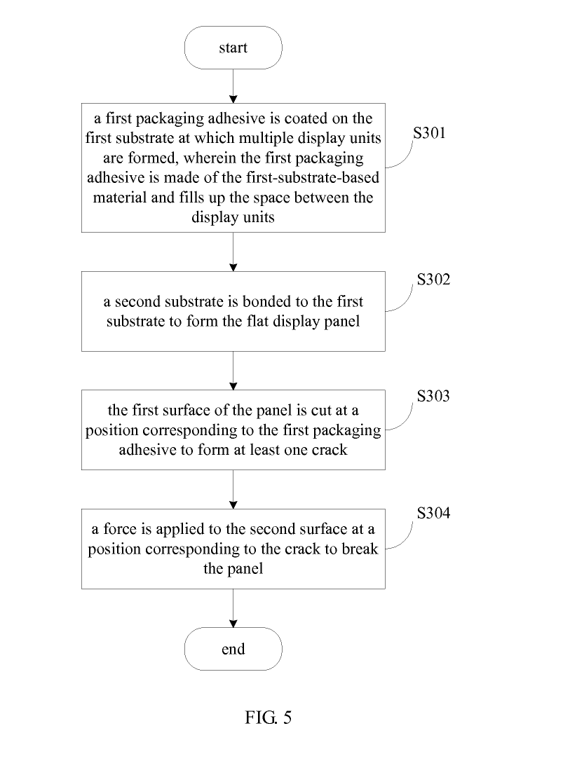

FIG. 5 illustrates a flowchart of a flat display panel cutting method for according to the second embodiment of the disclosure. As shown in FIG. 5, the steps are sequentially performed as follows to carry out the cutting method according to the present embodiment:

Step S301:

A first packaging adhesive 131 is coated on a surface of the first substrate 11 at which multiple display units are formed. The first packaging adhesive is made of the first-substrate-material-based material. The space between OLED units is filled with the first packaging adhesive 131. In particular, the first substrate 11 is made of transparent material, such as glass. Correspondingly, the first packaging adhesive 131 is made of glass-based material.

Step S302:

A second substrate 12 is bonded to a surface of the first substrate 11 at which a plurality of OLED units are formed to form the flat display panel 1. In particular, the material of the second substrate 12 is the same as that of the first substrate 11, which is a transparent material, such as glass etc.

Step S303:

The first surface 14 of the panel 1 is cut at a position corresponding to the first packaging adhesive 131 by a cutting tool to form at least one crack 141. In particular, the cutting tool 2 is a cutter or scribe-wheel with or without teeth, such as cutting roller, Tungsten steel cutting roller, glasscutter, laser or high-pressure water cutter etc.

Step S304:

A force is applied to the second surface 15 of the panel 1 at a position corresponding to the crack 141 by a splitting tool, so as to break the panel 1. The second surface is opposite to the first surface. In particular, the first packaging adhesive 131 is made of the first-substrate-based material, and the material of the second substrate 12 is the same as that of the first substrate 11. Therefore, the portion to be cut is formed into an integral structure with same material. When a force is applied to the second surface 15, the crack 141 on the first surface 14 extends to the second surface 15 through the first packaging adhesive 131 so as to break the panel 1. In particular, the splitting tool 3 may be a splitting rod, such as a rubber or plastic splitting rod etc.

In a modified embodiment, an edge grinding process is further performed on the separated panel 1 after Step S304. Cutting scratches are formed on the panel after the panel is divided. Thus, the cut panel is smoothed on the edge to flatten the edge so that the strength of the panel can be enhanced.

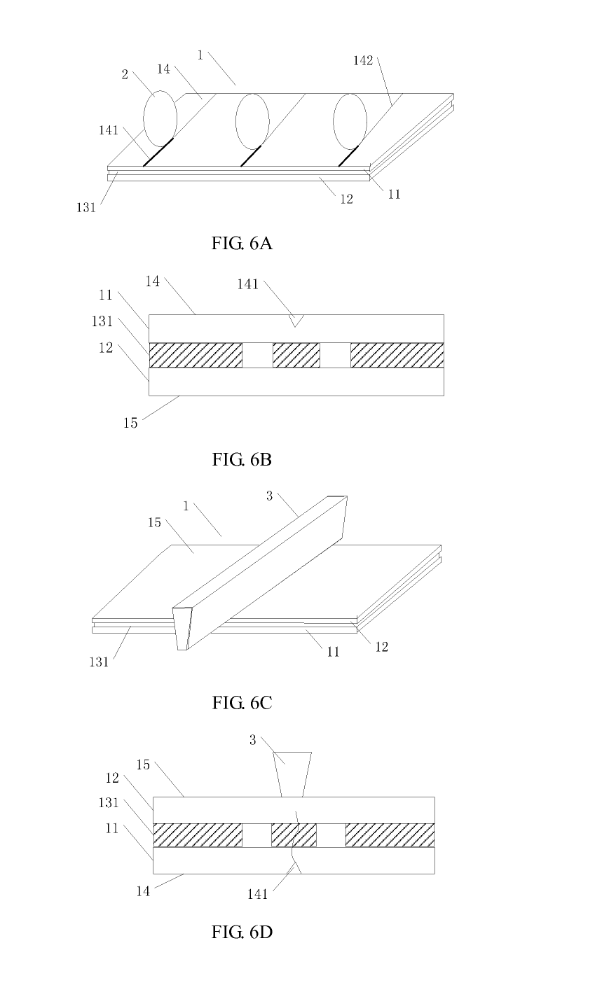

FIGS. 6A, 6B, 6C and 6D illustrate a schematic view of cutting and breaking process for the flat panel display according to the third embodiment of the disclosure.

FIG. 6A illustrates a schematic view of a flat display panel according to the third embodiment of the disclosure. As shown in FIG. 6A, the panel 1 comprises a first substrate 11, OLED units (not shown) provided at the lower surface of the first substrate 11, a second substrate 12, and a first packaging adhesive 131 made of the first-substrate-material-based material. The panel 1 has a first surface 14 and a second surface opposite to the first surface 14 (referring to the reference number 15 in FIG. 6B). Cutting marks 142 are formed on the first surface 14, and splitting marks (not shown) are formed on the second surface 15, which are corresponding to the cutting marks 142. The first substrate 11 is bonded to the second substrate 12 via the first packaging adhesive 131. During cutting, the second surface 15 acts as an upper surface of the panel 1. Additionally, FIG. 6A shows a cutting tool 2. The cutting tool 2 is used to cut on the cutting marks 142 on the first surface 14 of the panel 1 so as to form cracks 141.

FIG. 6B illustrates a cross sectional view of the flat display panel according to the third embodiment of the disclosure, in which the panel has been cut. As shown in FIG. 6B, the panel 1 comprises a first substrate 11, OLED units (not shown) provided at the lower surface of the first substrate 11, a second substrate 12, and a first packaging adhesive 13 made of the first-substrate-material-based material. The panel 1 has a first surface 14 and a second surface 15 opposite to the first surface 14. During cutting, the first surface 14 acts as an upper surface of the panel 1. The first substrate 11 is bonded to the second substrate 12 via the first packaging adhesive 131. The first packaging adhesive 131 at least covers portions corresponding to the cutting marks (referring to the reference number 142 in FIG. 6A). In particular, the first packaging adhesive 131 is further coated closely around each of the display units so as to form closed rings. The portions of the panel 1 corresponding to the cracks 141 are formed into an integral structure with same material.

FIG. 6C illustrates a schematic view of the structure of a flat display panel according to the third embodiment of the disclosure. As shown in FIG. 6C, the panel 1 comprises a first substrate 11, OLED units (not shown) provided at the lower surface of the first substrate 11, a second substrate 12, and a first packaging adhesive 131 made of the first-substrate-material-based material. The panel 1 has a first surface (referring to the reference number 14 in FIG. 6C) and a second surface 15 opposite to the first surface. The first substrate 11 is bonded to the second substrate 12 via the first packaging adhesive 131. During splitting, the second surface 15 acts as an upper surface of the panel 1. FIG. 6C also shows a splitting tool 3 for cutting the panel 1, such as a splitting rod. The splitting tool 3 applies a force to the splitting marks (not shown) on the second surface 15 of the panel 1, i.e. a position corresponding to the crack 141 on the first surface.

FIG. 6D illustrates a cross sectional view of the panel of the flat panel according to the third embodiment of the disclosure during splitting process. As shown in FIG. 6D, the panel 1 comprises a first substrate 11, OLED units (not shown) provided at the lower surface of the first substrate 11, a second substrate 12 corresponding to the first substrate 11, and a first packaging adhesive 131 made of the first-substrate-material-based material. The panel 1 has a first surface 14 and a second surface 15 opposite to the first surface 14. The first packaging adhesive 131 is used for packaging the display unit. The first substrate 11 is bonded to the second substrate 12 via the first packaging adhesive 131. During splitting the second surface 15 acts as an upper surface of the panel 1. FIG. 6D also shows a splitting tool 3 for cutting panel 1. The splitting tool 3 applies force to the position on the second surface 15 of the panel 1 corresponding to the crack 141 on the first surface 14. The first packaging adhesive 131 is made of the first-substrate-material-based material, and the material of the second substrate 12 is the same as that of the first substrate 11, therefore, the portion to be cut is formed into an integral structure with same material. When a force is applied on the second surface 15, the crack 141 on the first surface 14 extends to the second surface 15 through the first packaging adhesive 131 so as to break the panel.

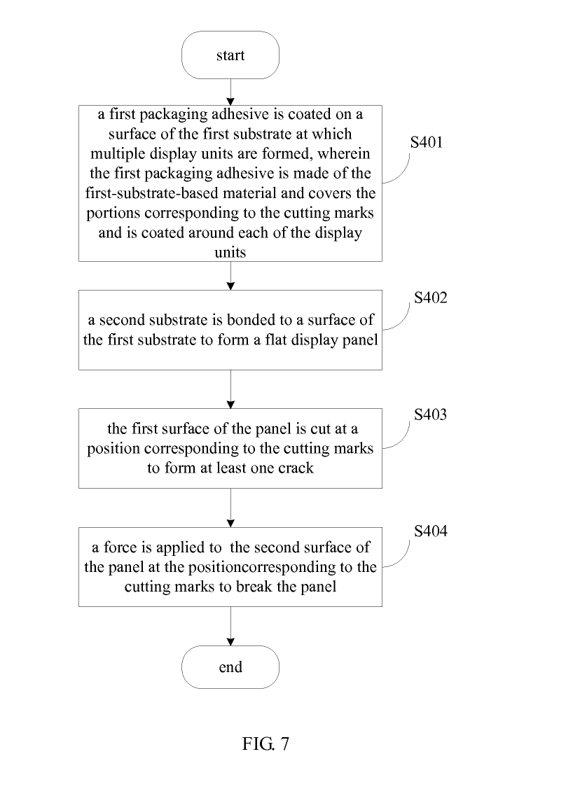

As shown in FIG. 7, the steps are sequentially performed as follows to carry out the cutting method according to the present embodiment:

Step S401: A packaging adhesive 131 is coated on a surface of the first substrate 11 at which multiple display units are formed. The first packaging adhesive 131 is made of the first-substrate-material-based material. The first packaging adhesive 131 at least covers the portions corresponding to the cutting marks. In particular, the first packaging adhesive 131 is further coated closely around each of the organic light-emitting display units so as to form a closed ring. In particular, the first substrate 11 is made of transparent material, such as glass. Correspondingly, the first packaging adhesive 131 is made of glass-based material.

Step S402: A second substrate 12 is bonded to a surface of the first substrate 11 at which a plurality of display units are formed to form the flat display panel 1. The second substrate 12 is corresponding to the first substrate 11. In particular, the material of the second substrate 12 is the same as that of the first substrate 11, which is a transparent material, such as glass etc.

Step S403: the first surface 14 of the panel 1 is cut at a position corresponding to the cutting marks 142 by a cutting tool to form at least one crack 141. In particular, the cutting tool 2 is a cutter or scribe-wheel with or without teeth, such as cutting roller, Tungsten steel cutting roller, glasscutter, laser or high-pressure water cutter etc.

Step S404: A force is applied to the second surface 15 of the panel 1 at a position corresponding to the cutting marks 142 by a splitting tool, so as to break the panel 1. In particular, the first packaging adhesive 131 is made of the first-substrate-material-based material, and the material of the second substrate 12 is the same as that of the first substrate 11. Therefore, the portion to be cut is formed into an integral structure with same material. When a force is applied on the second surface 15, the crack 141 on the first surface 14 extends to the second surface 15 through the first packaging adhesive 131 so as to break the panel 1. In particular, the splitting tool 3 may be a splitting rod, such as a rubber or plastic splitting rod etc.

In a modified embodiment, an edge grinding process is further performed on the separated panel 1 after Step S404. Cutting scratches are formed on the panel after the panel is broken, thus, the cut panel is smoothed on the edge to flatten the edge so that the strength of the panel can be enhanced.

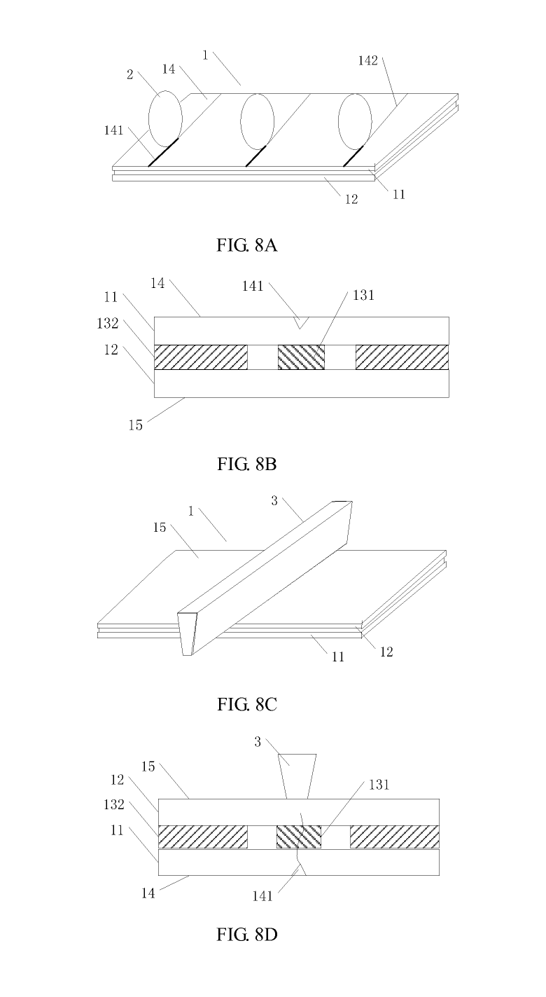

FIGS. 8A, 8B, 8C and 8D illustrate a schematic view of cutting and breaking process for the flat display panel according to the fourth embodiment of the disclosure.

FIG. 8A illustrates a schematic view of a flat display panel according to the fourth embodiment of the disclosure. As shown in FIG. 8A, the panel 1 comprises a first substrate 11, OLED units (not shown) provided at the lower surface of the first substrate 11, a second substrate 12 corresponding to the first substrate 11, and a first packaging adhesive 13 made of the first-substrate-material-based material. The panel 1 has a first surface 14 and a second surface (referring to the reference number 15 in FIG. 8B) opposite to the first surface 14. Cutting marks 142 are formed on the first surface 14, and splitting marks (not shown) are formed on the second surface 15 which are corresponding to the cutting marks 142. The first packaging adhesive 131 is used for packaging the display unit. The first substrate 11 is bonded to the second substrate 12 via the first packaging adhesive 131. During cutting the first surface 14 acts as an upper surface of the panel 1. FIG. 8A also shows a cutting tool 2. The cutting tool 2 is used to do cutting on the cutting marks 142 on the first surface 14 of the panel 1 so as to form cracks 141.

FIG. 8B illustrates a side section view of the flat display panel according to the fourth embodiment of the disclosure in which the panel has been cut. As shown in FIG. 8B, the panel 1 comprises a first substrate 11, OLED units (not shown) provided at the lower surface of the first substrate 11, a second substrate 12 corresponding to the first substrate 11, and a first packaging adhesive 131 made of the first-substrate-material-based material. The panel 1 has a first surface 14 and a second surface 15 opposite to the first surface 14. During cutting the first surface 14 acts as an upper surface of the panel 1. The first packaging adhesive 131 is used for packaging the display unit. The first substrate 11 is bonded to the second substrate 12 via the first packaging adhesive 131. The first packaging adhesive 131 is coated between the first substrate 11 and second substrate 12, and at least covers the portions corresponding to the cutting marks. The portions of the panel 1 corresponding to the cracks 141 are formed into an integral structure with same material. In particular, a second packaging adhesive 132 is coated closely around each of the display units so as to form a closed cycle. The second packaging adhesive 132 may be made of thermosetting materials or photocurable materials and can be hardened by heat or light so as to package the OLED units.

FIG. 8C illustrates a schematic view of a flat display panel according to the third embodiment of the disclosure. As shown in FIG. 8C, the panel 1 comprises a first substrate 11, OLED units (not shown) provided at the lower surface of the first substrate 11, a second substrate 12 corresponding to the first substrate 11, and a first packaging adhesive 131 made of the first-substrate-material-based material. The panel 1 has a first surface (referring to the reference number 14 in FIG. 4A) and a second surface 15 opposite to the first surface. The first packaging adhesive 131 is used for packaging the display unit. The first substrate 11 is bonded to the second substrate 12 via the first packaging adhesive 131. During splitting the second surface 15 acts as an upper surface of the panel 1. FIG. 8C also shows a splitting tool 3 for cutting panel 1, such as a splitting rod. The splitting tool 3 applies force to the splitting marks (not shown) on the second surface 15 of the panel 1, i.e. a position corresponding to the crack 141 on the first surface 14.

FIG. 8D illustrates a side section view of the panel of the flat panel according to the fourth embodiment of the disclosure during splitting process. As shown in FIG. 8D, the panel 1 comprises a first substrate 11, OLED units (not shown) provided at the lower surface of the first substrate 11, a second substrate 12 corresponding to the first substrate 11, and a first packaging adhesive 131 made of the first-substrate-material-based material. The panel 1 has a first surface 14 and a second surface 15 opposite to the first surface 14. The first packaging adhesive 131 is used for packaging the display unit. The first substrate 11 is bonded to the second substrate 12 via the first packaging adhesive 131. During splitting the second surface 15 acts as an upper surface of the panel 1. FIG. 8D also shows a splitting tool 3 for cutting panel 1. The splitting tool 3 applies force to the position on the second surface 15 of the panel 1 corresponding to the crack 141 on the first surface 14. The first packaging adhesive 131 is made of the first-substrate-material-based material, and the material of the second substrate 12 is the same as that of the first substrate 11, therefore the portion to be cut is formed into an integral structure with same material. When a force is applied on the second surface 15, the crack 141 on the first surface 14 extends to the second surface 15 through the first packaging adhesive 131 so as to break the panel.

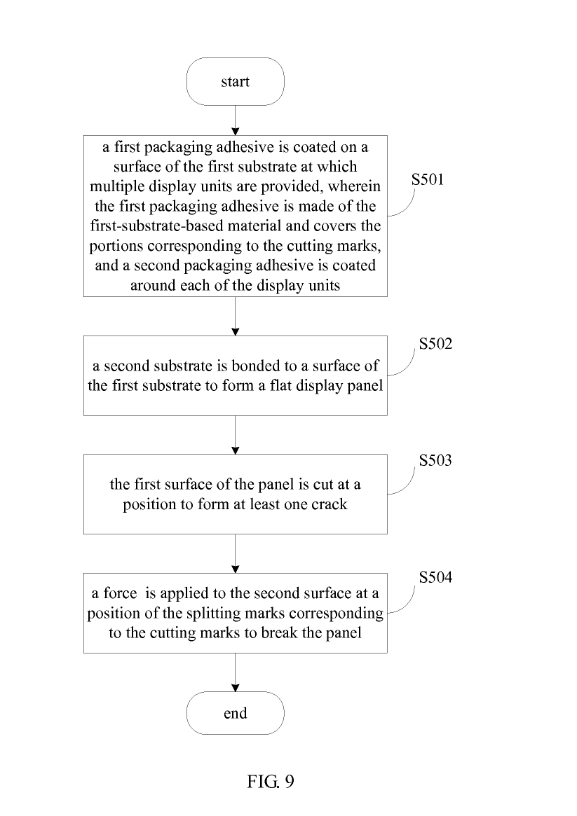

As shown in FIG. 9, the steps are sequentially performed as follows to carry out the cutting method according to the present embodiment:

Step S501: A first packaging adhesive 131 is coated on a surface of the first substrate 11 at which multiple display units is provided. The first packaging adhesive 131 is made of the first-substrate-material-based material. The first packaging adhesive 131 at least covers the portions corresponding to the cutting marks. In particular, the first substrate 11 is made of transparent material, such as glass. Correspondingly, the first packaging adhesive 131 is made of glass-based material. In particular, a second packaging adhesive 132 is coated closely around each of the organic light-emitting display units so as to form a closed ring. The second packaging adhesive 132 may be made of thermosetting materials or photocurable materials and may be hardened by heat or light so as to package the OLED units.

Step S502: A second substrate 12 is bonded to a surface of the first substrate 11 at which a plurality of organic light-emitting units are formed to form the flat display panel 1. The second substrate 12 is corresponding to the first substrate 11. In particular, the material of the second substrate 12 is the same as that of the first substrate 11, which is a transparent material, such as glass etc.

Step S503: The first surface 14 of the panel 1 is cut at a position corresponding to the cutting marks 142 by a cutting tool to form at least one crack 141. In particular, the cutting tool 2 is a cutter or scribe-wheel with or without teeth, such as cutting roller, Tungsten steel cutting roller, glasscutter, laser or high-pressure water cutter etc.

Step S504:A force is applied to the second surface 15 at a position of the splitting marks corresponding to the cutting marks 142 by a splitting tool 3, so as to break the panel 1. In particular, the first packaging adhesive 131 is made of the first-substrate-material-based material, and the material of the second substrate 12 is the same as that of the first substrate 11. Therefore, the portion to be cut is formed into an integral structure with same material. When a force is applied to the second surface 15, the crack 141 on the first surface 14 extends to the second surface 15 through the first packaging adhesive 131 so as to break the panel 1. In particular, the splitting tool 3 may be a splitting rod, such as a rubber or plastic splitting rod etc.

In a modified embodiment, an edge grinding process is further performed on the broken panel 1 after Step S504. Cutting scratches are formed on the panel after the panel is broken, thus, the cut panel is smoothed on the edge to flatten the edge so that the strength of the panel can be enhanced.

It should be noted that the above embodiments are only illustrated for describing the technical solution of the disclosure and not restrictive, and although the embodiments are described in detail by referring to the aforesaid embodiments, the skilled in the art should understand that the aforesaid embodiments can be modified and portions of the technical features therein may be equally changed, which does not depart from the spirit and scope of the technical solution of the embodiments of the disclosure.

What is claimed is:

1. A cutting method for a flat display panel composed of a first substrate and a second substrate, the method comprising the steps of:
coating a first packaging adhesive on a surface of a first substrate at which display units are formed, wherein the first substrate is formed of a first-substrate-material and the first packaging adhesive is made of a first-substrate-material-based material;
bonding a second substrate to the surface of the first substrate to form the panel, having a first surface and a second surface opposite to the first surface;
forming at least one crack on the first surface of the panel corresponding to the first packaging adhesive; and
applying a force on the second surface at a position corresponding to the at least one crack so as to break the panel.

2. The cutting method of claim 1, wherein the first and second substrates are made of transparent material.

3. The cutting method of claim 2, wherein the first and second substrates are made of acrylic glass.

4. The cutting method of claim 3, wherein the first packaging adhesive is made of acrylic-based material.

5. The cutting method of claim 1, wherein the first packaging adhesive fills up the spaces between the display units.

6. The cutting method of claim 1, wherein the first surface is provided with cutting marks, and the second surface is provided with splitting marks corresponding to the cutting marks.

7. The cutting method of claim 6, wherein the first packaging adhesive is at least coated between the display units and corresponding to the cutting marks.

8. The cutting method of claim 7, wherein the first packaging adhesive is further coated closely around each of the display units so as to form a closed ring.

9. The cutting method of claim 7, wherein the step of coating the first packaging adhesive further comprises:
coating a second packaging adhesive at the surface of the first substrate, wherein the second packaging adhesive is coated closely around each of the display units so as to form a closed ring and is made of a thermosetting material or a photocurable material.

10. The cutting method of claim 1, further comprises performing an edge grinding process to the panel after breaking the panel.

11. The cutting method of claim 1, wherein the cutting tool to make the mark is a scribe-wheel or cutter with teeth.

12. The cutting method of claim 1, wherein the cutting tool is a scribe-wheel or cutter without teeth.

13. The cutting method of claim 1, wherein a splitting tool used to break the panel is a splitting rod.

14. The cutting method of claim 13, wherein the splitting rod is a rubber or plastic splitting rod.

15. The cutting method of claim 13, wherein the flat display panel is an organic light-emitting display panel, and the display units are organic light-emitting display units.
